(19) United States
(12) Patent Application Publication
(10) Pub. No.: US 2018/0370104 A1
(43) Pub. Date: Dec. 27, 2018

(54) Deflecting Device for Deflecting a Melt Flow Inside a Distributing Plate

(71) Applicant: GÜNTHER Heisskanaltechnik GmbH, Frankenberg (DE)

(72) Inventors: Herbert GÜNTHER, Allendorf (DE); Siegrid SOMMER, Burgwald (DE); Torsten SCHNELL, Lichtenfels (DE)

(21) Appl. No.: 16/015,384

(22) Filed: Jun. 22, 2018

(30) Foreign Application Priority Data
Jun. 23, 2017 (DE) 10 2017 114 051.4
Dec. 14, 2017 (DE) 10 2017 130 014.7

(51) Int. Cl. B29C 45/27

(52) U.S. Cl. CPC B29C 45/2725

(57) ABSTRACT

The disclosure relates to a deflecting device, for deflecting a melt flow in a distributing plate of an injection molding machine, with a base body, wherein a deflecting channel is arranged inside the base body. In order to create an improved solution for diverting the melt flow in a hot runner manifold, the base body can have a separating surface which divides the base body into a first body half and a second body half, wherein the first body half and the second body half can be joined together firmly. The disclosure furthermore relates to a method for producing the deflecting device.

### CROSS-REFERENCE TO RELATED APPLICATIONS

This application claims priority to German Patent Application No. 10 2017 114 051.4 filed Jun. 23, 2017 and German Patent Application No. 10 2017 130 014.7 filed Dec. 14, 2017, which are incorporated by reference herein in their entirety.

### FIELD OF INVENTION

The invention relates to a deflecting device for deflecting a melt flow inside a distributing plate. Distributing plates (hot runner manifolds) are used in particular in injection molding machines in order to direct a melt or plasticized mass toward injection molding nozzles.

### BACKGROUND

Distributing plates are preferably fashioned as a single piece, for sealing reasons and on account of the high operating pressures. Distributing plates have here a runner system which is formed by longitudinal and transverse bores, by which the plasticized mass can be directed from one plane to another plane. The longitudinal and transverse bores cross at intersection points. Recesses are made in the distributing plate at these intersection points and at other positions along the bores perpendicular to the plane of the runner system, which recesses are suitable for accommodating deflecting devices.

The deflecting devices serve for deflecting the melt flow from the plane of the runner system situated in the distributing plate in the direction of injection molding nozzles of the injection molding machine. Furthermore, the deflecting devices serve to bound the flow of the plasticized mass, for example in the edge areas of the distributing plate.

The deflecting devices comprise a deflecting channel for the deflecting of the flow of the plasticized mass, which redirects the melt flow generally from a horizontal direction of the runner system of the distributing plate to a vertical direction. The deflecting devices are installed pressure-tight in the distributing plate here, so that the plasticized mass only emerges from the distributing plate at the openings of the deflecting devices.

DE 298 16 253 UI discloses one such distributing plate with deflecting plugs, wherein the deflecting plugs are cylindrically shaped and have such a formation in a lower end face that a melt flow can be redirected from a horizontally extending channel into a vertically extending channel, the horizontally extending channel being at the same time sealed off by the plugs. The plug here is inserted into the distributing plate at an angle to the horizontal plane of the runner system.

The drawback of this configuration is that the deflecting of the melt flow does not occur in a uniform channel. In particular, a flow backwater is formed in the transitional region between the horizontal and vertical course of the channel in the distributing plate by the structurally necessary sharp edge situated opposite the plug, resulting in a nonuniform and disadvantageous melt flow.

DE 20 2006 018 031 U1 likewise discloses distributing plates with deflecting plugs, wherein the deflecting plugs are cylindrically shaped and have on the inside thereof a channel geometry, for instance a curved flow channel. The plugs can be inserted into the horizontally extending runner system and make possible a deflecting of the melt flow in a vertical direction owing to a corresponding configuration of the curved flow channel.

A drawback of this configuration is that the deflecting plugs are formed as a single piece—or soldered in a parting plane. A single-piece conformation of the deflecting plugs requires, for example, a multiple-step machining process with repeated mounting of tools, such as boring tools. This produces nonuniform surfaces in the flow channel, favoring the occurrence of flow backwaters. An appropriate after-machining of such single-piece deflecting plugs with complex deflecting channel geometries is costly.

Starting from the above-described prior art, the problem which the present invention proposes to solve is to create an alternative and improved solution for the redirecting of the melt flow in a hot runner manifold and to eliminate the existing drawbacks of the prior art.

Furthermore, the problem which the invention proposes to solve is to provide a method for producing such a deflecting device.

This problem is solved according to the present invention by the disclosed device and method.

### SUMMARY OF INVENTION

A deflecting device for the deflecting of a melt flow in a distributing plate of an injection molding machine, with a base body, having a deflecting channel arranged inside the base body, and wherein the base body can have a separating surface which divides the base body into a first body half and a second body half, wherein the first body half and the second body half can be joined together firmly.

The divided base body is especially advantageous, since the deflecting device can be easily cleaned in this way. In particular, when changing tools the deflecting device can be removed from a distributing plate of an injection molding machine. The base body of the deflecting device can be separated along the separating surface, so that the channel is accessible at least for a portion. The firm connection of the body halves makes sure that the first and the second body half do not shift relative to each other. Because a firm connection is provided between the first body half and the second body half, the deflecting device is furthermore tight, especially under high operating pressures prevailing in injection molding machines. In this way, a sealed operation of the distributing plate with one or more deflecting devices is ensured. By providing a separating surface in the base body, an internal geometry of the base body, such as the deflecting channel, is particularly advantageously freely configurable along the separating surface in the respective plug half. Thus, the melt can be guided within the deflecting device in a gentle manner by an appropriate configuration of the deflecting channel, without the melt flow being hindered, disturbed or influenced at sharp edges inside the deflecting channel.

Preferably, it is proposed that the deflecting channel extends in the separating surface. This is especially advantageous for the cleaning of the deflecting device, since the deflecting channel lies exposed in the body halves after a separation of the base body along the separating surface. Furthermore, this embodiment of the invention is advantageous in regard to the production of the deflecting device, since after producing the body halves the deflecting channel can be introduced in almost any desired geometry into the body halves and thus into the base body by appropriate methods, such as a CNC chip removal method. Surface roughness values are achieved in this way that are not technically feasible by means of laser sintering or 3D printing, for example. In particular, the channel can be configured by its trajectory inside the separating surface such that no flow backwaters are created in the plasticized mass due to its geometry. Preferably, it is also proposed in this regard that a center axis of the base body lies in the separating surface.

Especially preferably, it is proposed that the deflecting channel has a vertical section, which extends substantially parallel to the center axis, and the deflecting channel has a radial section which extends substantially perpendicular to the center axis. The provision of the vertical section and the radial section produces a deflecting channel geometry which is especially advantageous for the deflecting of plasticized mass in distributing plates of injection molding machines. The flow of the plasticized mass can thus be received from one channel plane of the distributing plate by the radial section in the deflecting device and moved along the deflecting channel in the vertical direction of the vertical section. From there, the flow of plasticized mass can thus be fed advantageously to an injection molding nozzle situated perpendicular to the channel plane of the distributing plate.

An especially useful embodiment proposes that the deflecting channel has a curved section between the vertical section and the radial section. The provision of a curved section ensures that the deflecting channel has no bends causing flow backwaters in the melt flow.

A preferred modification proposes that a closure needle bushing extends concentric to the center axis of the base body and is connected to the vertical section of the deflecting channel. By providing a closure needle bushing having a connection to the vertical section of the deflecting channel, a closure needle can be led through the base body and brought into engagement for example with the channel end of an injection molding nozzle in order to close it. Furthermore, it is especially useful for the closure needle bushing to have a connection geometry for a sealing element. By providing a sealing element, the base body of the deflecting device can be sealed in the region of the closure needle bushing. This advantageously enables a sealed operation of injection molding machines which have injection molding nozzles with closure needles in connection with the deflecting device.

Preferably, it is proposed that the body halves have surfaces situated parallel to the separating surface, and at least one indentation is introduced into each of the surfaces. By providing indentations in the surfaces of the body halves, the bearing surface of the two body halves is reduced. In this way, an increased pressing force of the body halves against each other can be produced. With bearing surfaces so configured, the tightness of the deflecting device is significantly increased owing to the increased surface pressure.

Preferably, it is proposed that the first body half has through holes and the second body half has blind holes, as seen from the separating surface, while the through holes and the blind holes are situated in the region of the indentations and the deflecting channel is not situated in the region of the indentations. Because the blind holes and the through holes are situated in the region of the indentations, it is advantageously ensured that any lack of tightness due to the holes only affects the region of the indentations. In particular, because the deflecting channel is not situated in the region of the indentations, it is advantageously ensured that the deflecting channel is sealed off from the indentations. Preferably, moreover, it is proposed that the closure needle bushing is not situated in the region of the indentations. This ensures that the closure needle bushing is likewise sealed off from the indentations. Moreover, because the indentations are not situated in the region of the deflecting channel and/or the closure needle bushing, it is ensured that a sealing region is present around the deflecting channel and the closure needle bushing, in which the surfaces of the body halves come to lie against one another.

An especially useful embodiment proposes that the through holes of the first body half run substantially perpendicular to the separating surface and the blind holes of the second body half run substantially perpendicular to the separating surface, while the blind holes have an internal thread. The blind holes may alternatively also be configured as through holes. This configuration is advantageous, since the body halves may thus be screwed together with the aid of screw bolts. The screw bolts may be led through the through holes here, being brought into engagement with the internal threads of the blind holes. A preferred modification proposes that the through holes have an enlarged diameter on an outer side of the base body. This affords the advantage that the screw heads of the screw bolts can be brought into the area of the through holes having an enlarged diameter, and the screw heads can be brought far enough into this area so that they do not protrude beyond the base body. Furthermore, the enlarged diameter creates a bearing surface for the side of the screw heads facing toward the first surface of the first body half, on which the first body half can be braced against the second body half. In one configuration it is therefore proposed that the first body half and the second body half can be joined by means of screw bolts which run through the through holes of the first body half and are screwed into the blind holes of the second body half.

Another preferred embodiment proposes that the first body half and the second body half, as seen from the parting plane, have centering holes oriented substantially perpendicular to the separating surface, and centering pins can be arranged in the centering holes between the body halves. In particular, this advantageously allows the body halves to be oriented in a defined way with respect to each other owing to the centering holes and the centering pins.

Furthermore, it is especially useful that the base body has a flange on a first side. By the advantageous providing of a flange, the base body can be fixed on a distributing plate. The flange in this case serves as an abutment for an exact positioning of the deflecting device in the distributing plate. Especially preferably here, a groove is present in the attachment region of the flange, encircling the base body and extending on the flange in the circumferential direction of the base body. Owing to the groove extending in the circumferential direction, the deflecting device in the abutment region is spaced apart from the abutting object, such as a distributing plate. In particular, the assembly and disassembly of the deflecting device is simplified in this way.

In an optional embodiment it is proposed that the base body has a flange on a first side and the flange has an abutment face for the abutment of the deflecting device against a distributing plate.

Owing to the defined abutment face which is optionally provided, it is possible to press fit the base body or the deflecting device with a defined dimension, for example in a distributing plate. Furthermore, this ensures that the deflecting channel is always aligned for example with corresponding channels in the distributing plate. In one preferred configuration, the abutment face is arranged on a side of the flange opposite the first side. This is especially advantageous when the base body is press fitted into a distributing plate. In this case, the transitions between distributing plate and plug are exactly maintained, so that an aligned transition results.

In another embodiment it is proposed that the base body has a cylindrical shape. The cylindrical shape of the base body affords the advantage that the deflecting device is especially easy to produce. This also holds equally for the distributing plate in which the deflecting device is arranged. In this way, the deflecting device can be produced economically.

Another advantageous embodiment of the invention proposes that the base body has a conical shape. In particular, it may be provided that the conical shape is configured such that the diameter of the base body decreases from the first side in the direction of a second side. Thus, the base body has a conicity tapering in the direction of the second side. Owing to a conical shape of the base body, it is especially easy to insert it into the distributing plate. Therefore, the base body is preferably configured conically so that the base body is conically tapering in a direction pointing into the distributing plate.

Preferably, it is proposed that the base body comprises a material having a positive coefficient of thermal expansion. Owing to a positive coefficient of thermal expansion, the deflecting device can advantageously be inserted firmly in a distributing plate as long as the distributing plate comprises a material with a lower coefficient of thermal expansion. The higher the operating temperature of the injection molding machine, the tighter the connection between deflecting device and distributing plate. Furthermore, the body halves are joined firmly together by the press fit arising on account of the different coefficient of thermal expansion at an elevated temperature of the distributing plate and the plug. A material expansion of the base body can be achieved by a temperature rise during the operation in injection molding machines, by which a press fit can be formed between the base body and the distributing plate of the injection molding machine. Preferably, for this, the coefficient of thermal expansion of the base body is larger than the coefficient of thermal expansion of the distributing plate.

In another embodiment of the deflecting device it is proposed that the base body and the distributing plate each comprise a material having a similar coefficient of thermal expansion. In one modification, it may furthermore be provided that the base body and the distributing plate each comprise a material having the same or a virtually identical coefficient of thermal expansion. The base body and the distributing plate preferably comprise the same material. An oversized base body having a significantly lower temperature than the distributing plate is advantageously easy to install in the distributing plate here. In this way, a press fit can be formed between the base body and the distributing plate, as long as the distributing plate and the base body have a substantially similar temperature. By providing a press fit between the base body and the distributing plate, the two body halves can be firmly joined together. As long as the base body is not oversized relative to the distributing plate, the base body can always be easily installed in the distributing plate and removed from it.

In another embodiment of the deflecting device it is proposed that the coefficient of thermal expansion of the material of the base body is larger than the coefficient of thermal expansion of the material of the distributing plate. In this way, a press fit between the base body and the distributing plate can be advantageously produced when both the distributing plate and the base body are heated. This generally occurs when the injection molding machine is in operation. When the injection molding machine is out of operation, for example for maintenance and/or cleaning purposes, advantageously no press fit exists, so that the base body can be separated from the distributing plate.

Furthermore, the invention relates to a method for producing the deflecting device. The method for producing at least one deflecting device comprises here the following method steps for the machining of a blank with a machining surface:

a. introducing a deflecting channel structure into the machining surface of the blank;
b. planing the machining surface;
c. dividing the blank along at least one parting plane into at least one first blank piece and at least one second blank piece;
d. machining the blank pieces to produce the outside of the base body comprising the body halves on the sides facing away from the machining surface.

By providing a parting plane in the blank, both blank pieces and the body halves resulting from the machining can be produced for each machining in a single work step in an appropriately designed fixture with regard to the machining of the surfaces of the two body halves. Thus, it is not necessary to perform separate machining of the machining surfaces or other surfaces for each blank piece or body half. By dividing the blank into the blank pieces along the at least one parting plane, the deflecting channel structure is given an especially precise orientation in regard to its position, insofar as it runs through the parting plane. In particular, the positioning of the deflecting channel structure in the separation area inside the blank pieces can be accomplished consistently for the resulting blank pieces by the separation along the parting plane. It is thus possible to produce especially accurately oriented structures in the machining surfaces of the blank pieces relative to the other respective blank piece. Owing to the separation of the blank pieces, further machining steps can be performed, for example, on surfaces other than the machining surface of the blank. Owing to the separate machining of the blank pieces, different machining can preferably be carried out for each blank piece.

A modification of the method proposes that the deflecting channel structure is introduced with mirror symmetry into the machining surface of the blank along at least one parting plane standing perpendicular to the machining surface.

The mirror symmetry affords the advantage that the blank pieces arising by the separation of the blank along the parting plane have a congruent deflecting channel structure when they are oriented toward each other by the machining surfaces. In particular, a deflecting channel can be produced in this way that has respectively one deflecting channel half in one of the blank pieces.

A preferred modification of the method proposes that the deflecting channel structure is introduced into the machining surface of the blank such that it is introduced with rotational mirror symmetry along a second parting plane which is a rotary mirror plane and stands perpendicular to the first parting plane.

By providing a deflecting channel structure of rotary mirror symmetry with two parting planes, the blank can be utilized especially advantageously for the production of four blank pieces, each time two blank pieces forming a pair of blank pieces having congruent deflecting channel structures when oriented toward each other by the machining surfaces.

An especially preferred modification of the method proposes that indentations are introduced into the machining surface of the blank such that the indentations are introduced into the blank with mirror symmetry along at least one parting plane standing perpendicular to the machining surface.

The mirror symmetry affords the advantage that the blank pieces formed by the separation of the blank along the parting plane have congruent indentations when they are oriented toward each other by the machining surfaces. In particular, sealing surfaces can be produced in this way which are not situated in the area of the indentations, and an always adequate surface pressure between the sealing surfaces is achieved.

Alternatively, it is proposed for the method that bores are introduced into the machining surface of the blank such that the bores are introduced into the blank with mirror symmetry along at least one parting plane standing perpendicular to the machining surface, and the bores form the through holes and the blind holes.

Furthermore, it is especially preferably proposed for the method that the bores are introduced in the region of indentations. Moreover, it is proposed in one preferred modification of the method that the blind holes are provided with internal threads in a further step of the method.

Owing to the mirror symmetry of the bores, the bores are advantageously congruent when the blank pieces are oriented toward each other by the machining surfaces. The provision of internal threads in the blind holes affords a further advantage that blank pieces or body halves can be braced by suitable clamping devices, such as screw bolts which are placed through the through holes and engage in the congruent blind holes with internal thread. By the advantageous producing of bores in the area of indentations, sealing surfaces which are present between the indentations are not adversely affected by bores.

### BRIEF DESCRIPTION OF THE DRAWINGS

Further features, details and advantages of the invention will emerge from the wording of the claims as well as the following description of exemplary embodiments with the aid of the drawings. There are shown:

FIG. 1 a schematic exploded representation of the deflecting device in a perspective view,

FIG. 2 the first body half in a schematic perspective view,

FIG. 3 the second body half in a schematic perspective view,

FIG. 4 the blank used for the method of producing the deflecting device in a top view,

FIG. 5 the blank used for the method of producing the deflecting device in a perspective view,

FIG. 6 a schematic representation of a conical configuration of the deflecting device in a perspective view and

FIG. 7 a schematic cross sectional view of the conical configuration of the deflecting device installed in a distributing plate.

### DETAILED DESCRIPTION

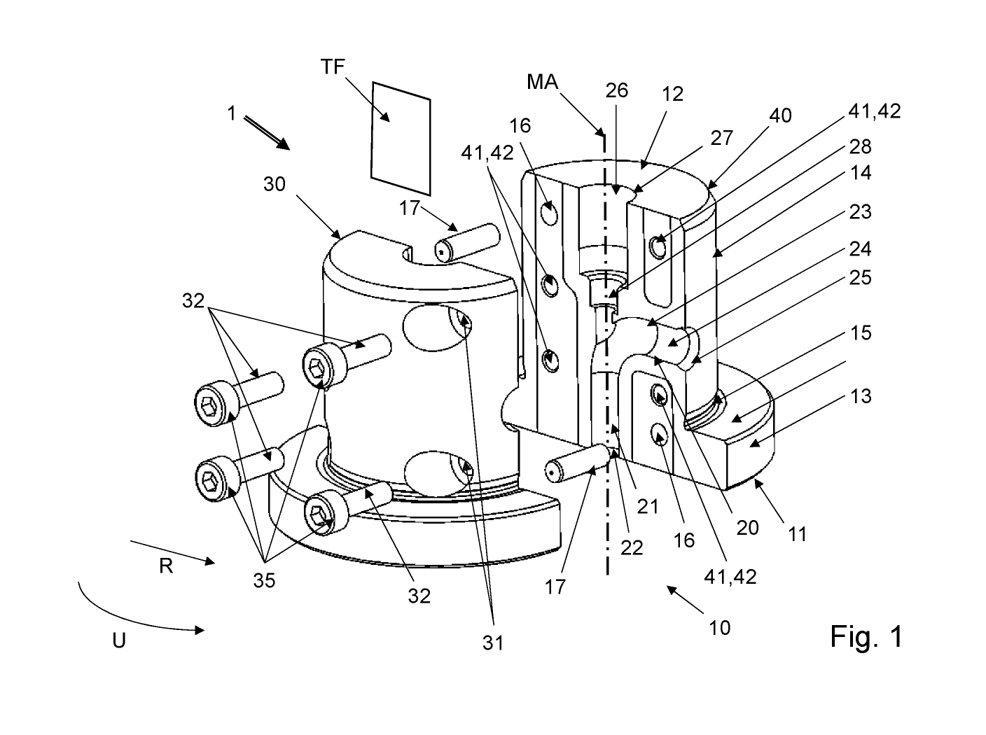

FIG. 1 shows the deflecting device 1. The deflecting device 1 comprises a base body 10. The base body 10 has a substantially cylindrical shape with a first side 11 and a second side 12. The base body 10 is shown divided along a separating surface TF, wherein a center axis MA of the base body 10 extends in the separating surface TF. The base body 10 furthermore has a flange 13 on its first side 11. The flange 13 extends substantially perpendicular to the center axis MA. In a connection region of the flange 13 on an outer side 14 of the base body 10, the outer side 14 and the flange 13 have a groove 15 extending in the circumferential direction U, situated in an abutment face 18.

Owing to the abutment face 18, the deflecting device 1 may be inserted flush into a distributing plate. The defined abutment face 18 on a surface of the flange 13 facing toward the second side ensures a defined depth of penetration of the deflecting device 1 into the distributing plate. Thus, transitions between the deflecting device 1 and the distributing plate are avoided.

The base body 10 furthermore has a deflecting channel 20 with a vertical section 21, extending from a first opening 22 in the first side 11 of the base body 10 parallel, and especially preferably concentric, to the center axis MA. The vertical section 21 passes into a curved section 23, which passes into a radial section 24. The radial section 24 runs perpendicular to the center axis MA in a radial direction R and intersects the outside 14 of the base body 10 with a second opening 25. The deflecting channel 20 lies parallel to the separating surface TF of the base body 10. The second opening 25 may have a bevel on the outside 14 of the base body 10, which can compensate for orienting errors between the base body 10 and the second opening 25 of corresponding channels of a distributing plate in which the base body 10 can be installed. Furthermore, this avoids undercuts between the base body 10 and the distributing plate.

Furthermore, the base body 10 comprises a closure needle bushing 26, which extends from the second side 12 through a third opening 27 parallel to the center axis MA in the direction of the vertical section 21 of the deflecting channel 20, especially preferably concentric to the center axis MA. The closure needle bushing 26 intersects the deflecting channel 20. Furthermore, the closure needle bushing 26 has a connection geometry 28 by which a sealing element may be attached to the base body 10. The closure needle bushing 26 lies with the deflecting channel 20 in the separating surface TF. Along the separating surface TF, the base body 10 is divided into a first body half 30 and a second body half 40.

The body halves 30, 40 of the base body 10 may be joined to each other. For this, the base body 10 comprises a material which has a positive coefficient of thermal expansion. By virtue of the positive coefficient of thermal expansion, when the temperature is increased an increase occurs in the volume of the material, by which the base body 10 forms a press fit in a corresponding formation of a distributing plate. In order to form the press fit, the coefficient of thermal expansion of the base body 10 is greater than the coefficient of thermal expansion of the distributing plate.

In another configuration it may be provided that the base body 10 and the distributing plate have the same coefficient of thermal expansion or the base body 10 has a larger coefficient of thermal expansion than the distributing plate. In this case, the press fit is formed by a heating of the distributing plate and a following inserting of the base body 10, having a much lower temperature than the distributing plate, into a corresponding recess of the distributing plate. In this way, the base body 10 is shrink-fitted into the distributing plate. Likewise, the base body 10 may also be cooled down relative to the distributing plate. In this case, the press fit is accomplished by the temperature equalization and the associated expanding of the base body 10.

Alternatively, it may be provided that the base body 10 and the distributing plate each comprise a material having substantially the same coefficient of thermal expansion. In this case, the base body 10 or the deflecting device 1 can always be easily taken out from the distributing plate or inserted therein.

Furthermore, centering pins 17 are arranged between the first body half 30 and the second body half 40, which can be brought into engagement with corresponding centering holes 16 of the first body half 30 and the second body half 40. The centering holes 16 are formed here as core holes. The embodiment of the connection of the body halves 30, 40 of the base body 10 by means of the temperature-dependent press fitting and by means of the centering pins 17 constitutes a first configuration for the connection of the body halves 30, 40.

According to another configuration, screw bolts 32 may be led from the outside 14 through through-holes 31 of the first body half 30, the screw bolts 32 being screwed into blind holes 41 of the second body half 40, wherein the blind holes 41 of the second body half 40 correspond to the through holes 31 of the first body half 30 in regard to their position in the base body 10. In order to make a connection of the two body halves 30, 40 by means of the screw bolts 32, the blind holes 41 each have an internal thread 42.

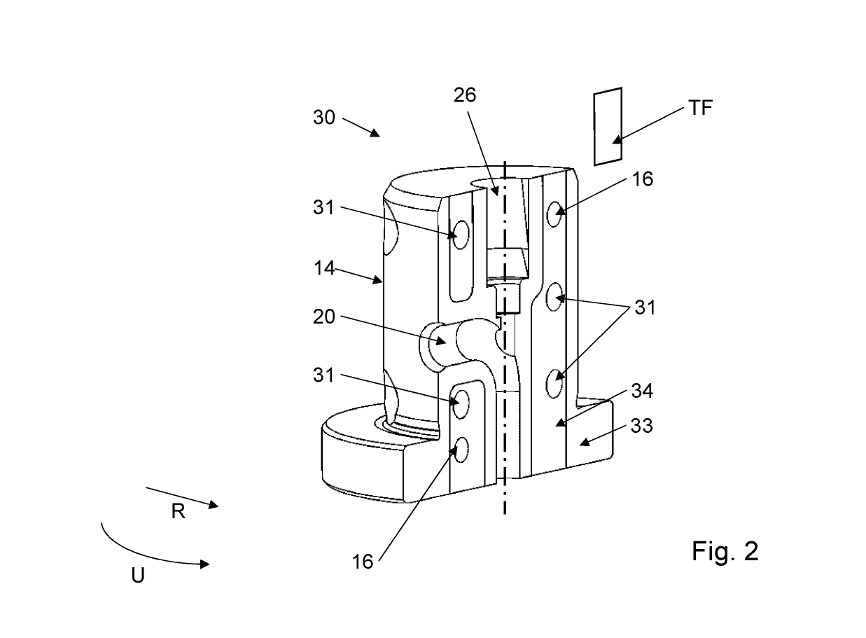

The screwing together of the body halves 30, 40 together with the temperature-dependent press fitting and the centering pins may alternatively form a further embodiment of the connection of the two body halves 30, 40. FIG. 2 shows the first body half 30 of the base body 10 with the deflecting channel 20 divided along the separating surface TF and the divided closure needle bushing 26. The first body half 30 has a first surface 33 running parallel to the separating surface TF, in which first indentations 34 are made. The first indentations 34 are situated in regions in which, as seen from the first surface 33, the through holes 31 and the centering holes 16 are devised in the first body half 30. The first indentations 34 encompass areas not intersecting either the edges of the deflecting channel 20 or the closure needle bushing 26. Thus, an elevated region of the first surface 33 relative to the first indentations 34 is present between the first indentations 34 and the deflecting channel 20 and the closure bushing 26. The through holes 31 have an enlarged diameter in the region of the outside 14 of the base body 10, so that a screw head 35 of a screw bolt 32 finds an abutment in the respective through hole 31, while in a mounted state—as seen radially—the screw head 35 does not protrude beyond the base body 10.

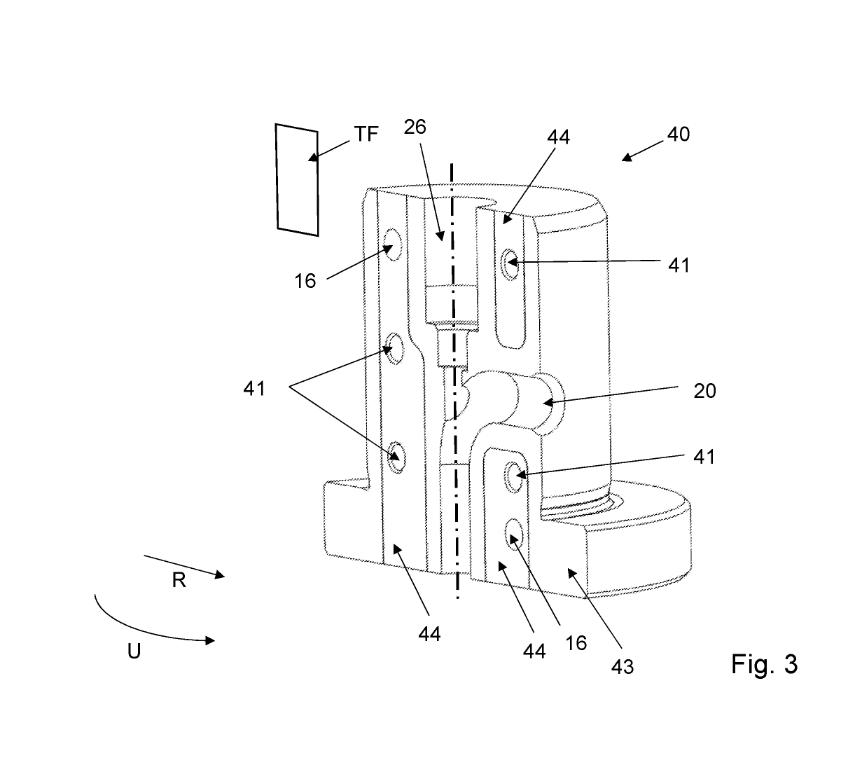

FIG. 3 shows the second body half 40, with the deflecting channel 20 divided along the separating surface TF, and the divided closure needle bushing 26. The second body half 40 has a second surface 43 running parallel to the separating surface TF, in which second indentations 44 are made. The second indentations 44 are situated in regions in which, as seen from the second surface 43, the blind holes 41 and the centering hole 16 are devised in the second body half 40. The second indentations 44 encompass areas not intersecting either the edges of the deflecting channel 20 or the closure needle bushing 26. Thus, an elevated region of the second surface 43 relative to the second indentations 44 is present between the second indentations 44 and the deflecting channel 20 and the closure needle bushing 26.

Owing to the indentations 34, 44 and the associated reduction in the surfaces 33, 43 of the two body halves 30, 40, the pressing force is increased in producing the connection joining the two body halves 30, 40.

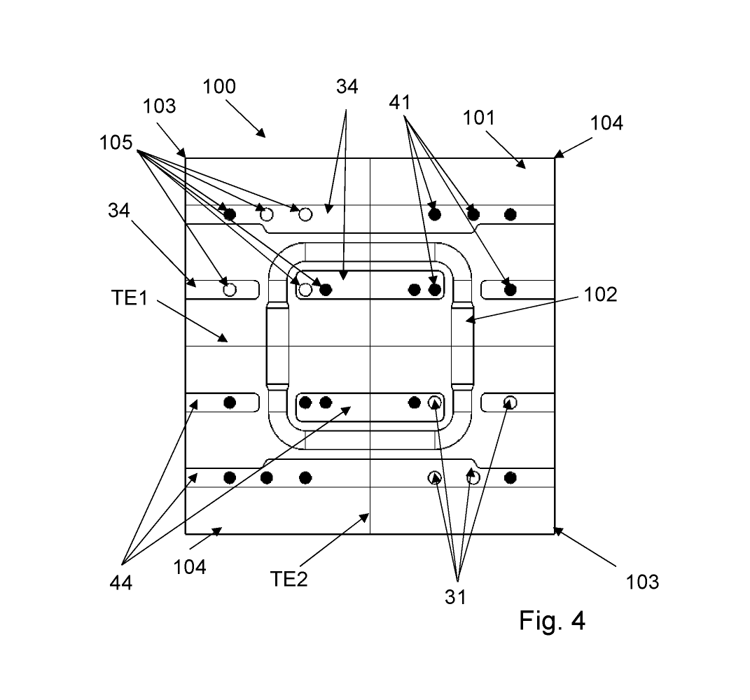

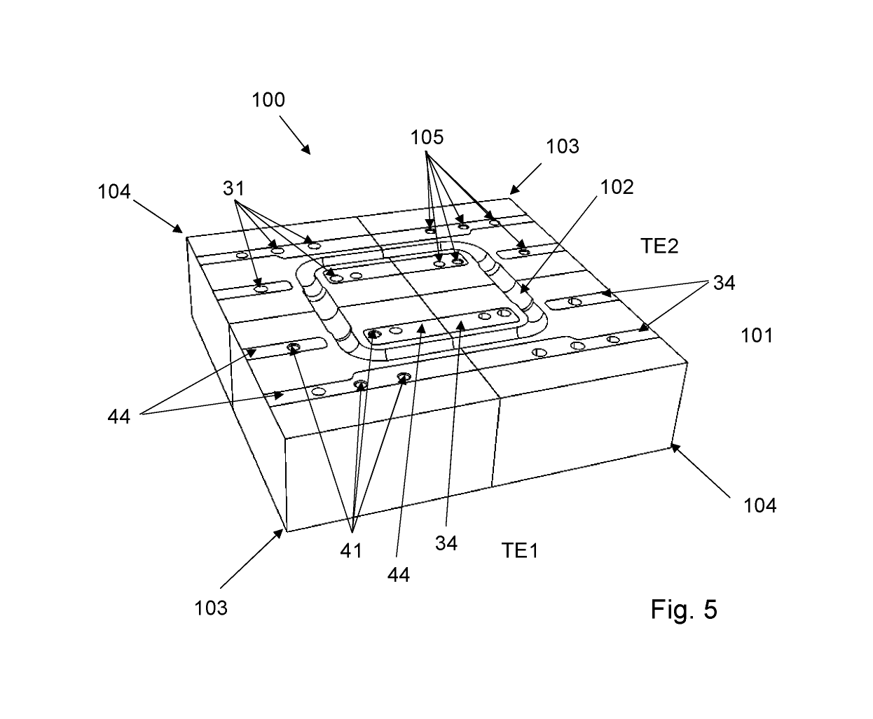

FIG. 4 and FIG. 5 show the blank 100 with the machining surface 101 for performing the method of production of the deflecting device 1. The blank in this configuration is formed as a cuboid, and the machining surface 101 is substantially a square. The sides of the square machining surface 101 are cut roughly in half by a first parting plane TE1 and a second parting plane TE2, the parting planes TE1, TE2 being oriented perpendicular to each other and perpendicular to the machining surface 101. A deflecting channel structure 102, indentations 34, 44 and bores 105 are machined in the machining surface 101. The bores 105 are fashioned as through holes 31 and as blind holes 41. The deflecting channel structure 102, the indentations 34, 44 and the bores 105 are devised in the machining surface 101 such as to possess a symmetry, the parting plane TE1 and the parting plane TE2 acting as rotary mirror symmetry planes. In this way, by dividing the blank 100 along the parting planes TE1 and TE2, two pairs of a first blank piece 103 and a second blank piece 104 are generated, having a pronounced mirror image machining of the machining surface 101. Owing to the pronounced mirror image machining of the machining surfaces 101, the first blank pieces 103 and second blank pieces 104 can be coordinated with each other by the machining surfaces 101, so that the machined features lie directly above each other. Because the machining is done on the blank 100, the blank pieces 103, 104 can be made exactly congruent in regard to their machining.

In order to produce the first body half 30 and second body half 40 forming the base body 10, the first blank piece 103 and the second blank piece 104 are machined in a further method step on the sides facing away from the machining surface 101, so that they possess the corresponding geometry of the base body 10. For this, the through holes 31 and the blind holes 41 serve as engagement positions for centering pins 17 and tools, so that the blank pieces 103, 104 can be oriented and secured for the further machining.

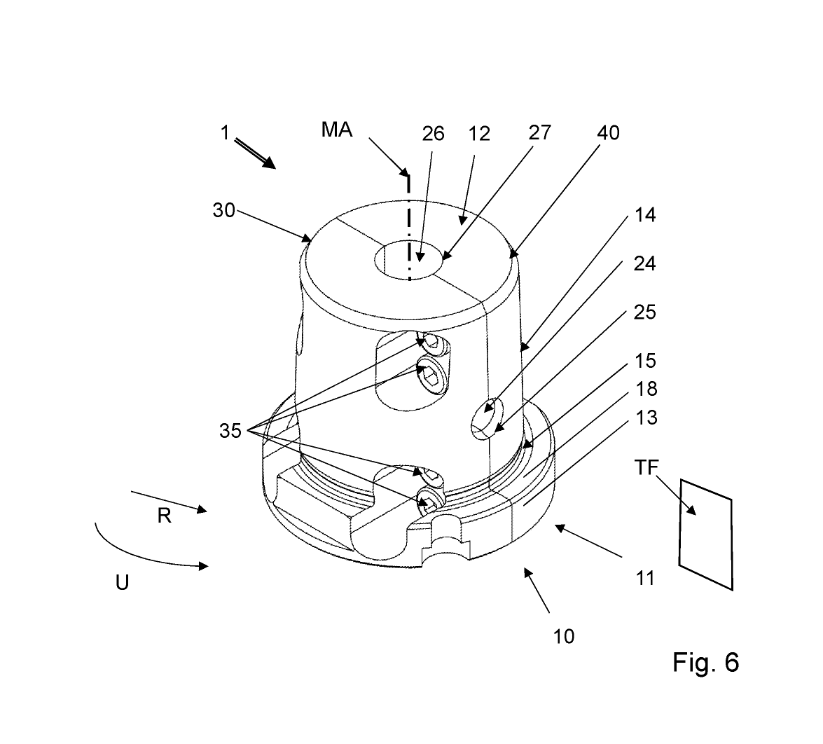

FIG. 6 shows another embodiment of the deflecting device 1 with a conical base body 10. One notices that the diameter of the base body 10 decreases from the first side 11 in a direction parallel to the center axis MA toward the second side 12. The base body 10 thus has a tapering conicity in the direction of the second side 12.

This deflecting device 1 likewise has a first side 11 and a second side 12, like the configuration of FIGS. 1 to 3. The conical base body 10 in this configuration tapers from the first side 11 to the second side 12. Furthermore, the deflecting device 1 has a flange 13 at the first side 11. In the transition region of the flange 13 with the abutment face 18 and base body 10, a groove 14 is arranged, which protrudes into the outside 14 of the deflecting device 1. Perpendicular to the center axis MA runs a closure needle bushing 26, which emerges in the third opening 27 on the second side 12.

The deflecting device 1 is divided into a first body half 30 and a second body half 40. The body halves 30, 40 are joined together on a separating surface TF. The separating surface TF runs parallel to the center axis MA of the deflecting device 1.

A radial section 24 of a deflecting channel, running in the body halves 30, 40 along the separating surface TF, comprises a radial section 24, which emerges in the second opening 25 on the outside 14 of the deflecting device 1.

The body halves 30, 40 are held together by screw bolts with screw heads 35, as long as the deflecting device 1 is not mounted in the distributing plate.

In a special embodiment, the base body 10 comprises a material having a similar coefficient of thermal expansion, preferably the same coefficient of thermal expansion, as the material of the distributing plate. In this way, the base body 10 is easily interchangeable. As long as the base body 10 is produced oversized, the base body 10 can be inserted into the distributing plate if it has a lower temperature than the temperature of the distributing plate. Equalization of the temperatures produces a press fit between the base body 10 and the distributing plate, which can be released by producing a corresponding temperature difference.

In a further embodiment, the base body 10 comprises a material having a larger coefficient of thermal expansion than the material of the distributing plate. In this case, a press fit is produced between the base body 10 and the distributing plate when the injection molding machine is at operating temperature.

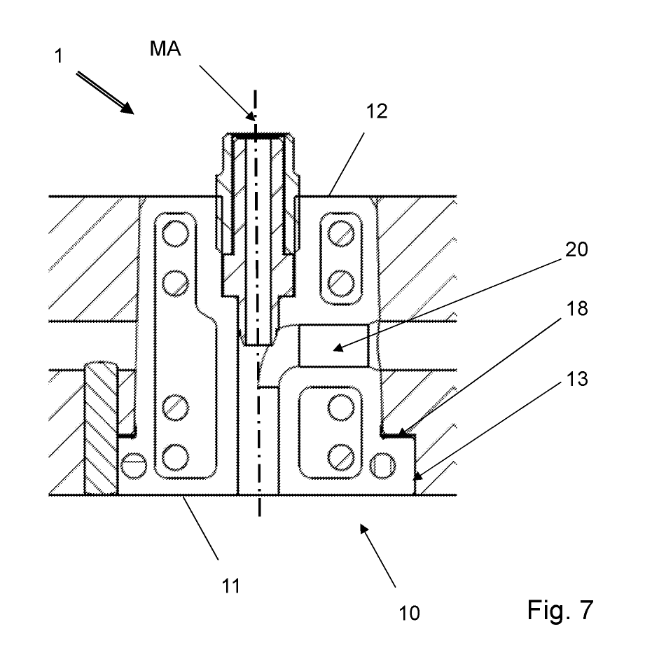

FIG. 7 shows a schematic cross sectional view of the conical configuration of the deflecting device 1 installed in a distributing plate. The base body 10 is installed in the distributing plate and closes off flush relative to the distributing plate surrounding the base body 10 by its first side 11 and second side 12. The distributing plate has a radial recess in the installation region of the deflecting device 1, in which the flange 13 is inserted. The radial recess has an end stop, against which the abutment face 18 of the flange 13 lies. Thus, the deflecting device 1 is secured in a direction parallel to the center axis MA. In this way it may be advantageously achieved that the deflecting channel 20 can be brought into congruency with a channel present in the distributing plate. Furthermore, the deflecting device 1 can be press-fitted into the distributing plate with a predefined dimension.

The invention is not confined to one of the above-described configurations, but instead it may be modified in many ways. It will be evident that a deflecting device 1 for the deflecting of a melt flow in a distributing plate of an injection molding machine has a base body 10, and inside the base body there is arranged a deflecting channel 20. In order to create an improved solution for the redirecting of the melt flow in a hot runner manifold, the base body 10 can have a separating surface TF, which divides the base body 10 into a first body half 30 and a second body half 40, while the first body half 30 and the second body half 40 can be firmly joined to each other.

The invention furthermore relates to a method for producing the deflecting device, wherein a deflecting channel structure 102 is worked into a machining surface 101 of a blank 100. After this, the machining surface 101 is planed, i.e., ground or polished flat, and the blank 100 is divided along at least one parting plane TE1, TE2 into at least one first blank piece 103 and at least one second blank piece 104. After this, the blank pieces 103, 104 are assembled into a deflecting device 1 in that the deflecting channel structures 102 formed in the blank pieces 103, 104 supplement each other to form a deflecting channel 20 and the blank pieces 103, 104 form the base body 10. After this, to produce the outside 14, the blank pieces 103, 104 forming the body halves 30, 40 are machined on the sides facing away from the machining surface 101.

All the features and advantages emerging from the claims, the description and the drawing, including structural details, spatial arrangements, and method steps, may be essential to the invention either in themselves or in the different combinations.

### LIST OF REFERENCE SYMBOLS

1 Deflecting device
10 Base body
11 First side
12 Second side
13 Flange
14 Outside
15 Groove
16 Centering hole
17 Centering pin
18 Abutment face
20 Deflecting channel
21 Vertical section
22 First opening
23 Curved section
24 Radial section
25 Second opening
26 Closure needle bushing
27 Third opening
28 Connection geometry
30 First body half
31 Through hole
32 Screw bolt
33 First surface
34 First indentation
35 Screw head
40 Second body half
41 Blind hole
42 Internal thread
43 Second surface
44 Second indentation
100 Blank
101 Machining surface
102 Deflecting channel structure
103 First blank piece
104 Second blank piece
105 Bores
U Circumferential direction
MA Center axis
TF Separating surface
R Radial direction
TE1 First parting plane
TE2 Second parting plane

What is claimed is:

1. A deflecting device, for deflecting a melt flow in a distributing plate of an injection molding machine, with a base body, wherein a deflecting channel is arranged inside the base body, wherein the base body has a separating surface which divides the base body into a first body half and a second body half, wherein the first body half and the second body half can be joined together firmly.

2. The deflecting device as claimed in claim 1, wherein the deflecting channel extends in the separating surface.

3. The deflecting device as claimed in claim 1, wherein a center axis of the base body lies in the separating surface.

4. The deflecting device as claimed in claim 1, wherein the base body has a flange on a first side and the flange has an abutment face for the abutment of the deflecting device against the distributing plate.

5. The deflecting device as claimed in claim 1, wherein the deflecting channel has a vertical section, which extends substantially parallel to a center axis of the base body and the deflecting channel has a radial section which extends substantially perpendicular to the center axis.

6. The deflecting device as claimed in claim 5, wherein the deflecting channel has a curved section between the vertical section and the radial section.

7. The deflecting device as claimed in claim 5, wherein a closure needle bushing extends concentric to the center axis of the base body and is connected to the vertical section of the deflecting channel.

8. The deflecting device as claimed in claim 1, wherein the first body half has a first surface and the second body half has a second surface, wherein the first surface and the second surface are each situated parallel to the separating surface, and wherein the first surface and the second surface each comprise at least one indentation.

9. The deflecting device as claimed in claim 1, wherein the base body has a cylindrical shape.

10. The deflecting device as claimed in one claim 1, wherein the base body has a conical shape.

11. The deflecting device as claimed in claim 1, wherein the base body comprises a material having a positive coefficient of thermal expansion.

12. The deflecting device as claimed in claim 1, wherein the base body and the distributing plate each comprise a material having a similar coefficient of thermal expansion.

13. The deflecting device as claimed in claim 1, wherein a coefficient of thermal expansion of a material of the base body is larger than a coefficient of thermal expansion of a material of the distributing plate.

14. A method for producing at least one deflecting device as claimed in claim 1, comprising the following method steps for the machining of a blank with a machining surface:
introducing a deflecting channel structure into the machining surface of the blank;
planing the machining surface;
dividing the blank along at least one parting plane into at least one first blank piece and at least one second blank piece; and
machining the blank pieces to produce the outside of the base body comprising the body halves on the sides facing away from the machining surface.

15. The method as claimed in claim 14, wherein the deflecting channel structure is introduced with mirror symmetry into the machining surface of the blank along the at least one parting plane standing perpendicular to the machining surface.

16. The method as claimed in claim 15, wherein the deflecting channel structure is introduced into the machining surface of the blank such that it is introduced with rotational mirror symmetry along a second parting plane which is a rotary mirror plane and stands perpendicular to the first parting plane.
